(19) United States
(12) Patent Application Publication
(10) Pub. No.: US 2014/0248151 A1
(43) Pub. Date: Sep. 4, 2014

(54) FLOATING WATER WAVE ENERGY COLLECTING AND TRANSDUCING SYSTEM

(71) Applicants: Wanzhang Dong, Shenzhen (CN); Guilin Wang, Shenzhen (CN)

(72) Inventors: Wanzhang Dong, Shenzhen (CN); Guilin Wang, Shenzhen (CN)

(73) Assignee: SHENZHEN ROMER ENVIRONMENTAL ENGINEERING CO., LTD., Shenzhen (CN)

(21) Appl. No.: 14/235,717

(22) PCT Filed: May 30, 2012
(86) PCT No.: PCT/CN2012/076282

§ 371 Date: May 12, 2014

(30) Foreign Application Priority Data
Jul. 28, 2011 (CN) 201110213521.1

(51) Int. Cl. F03B 3/12

(52) U.S. Cl. CPC F03B 3/12
USPC 416/84

(57) ABSTRACT

Provided is a floating water wave energy collection and conversion system, which comprises at least two buoyant members (101, 102) floating on the surface of the water and connected movably with each other in series, wherein the movable connection can be a hinged connection. A power transmission device and an energy conversion device (103) are provided on the buoyant members and the power transmission device and the energy conversion device (103) of adjacent buoyant members (101, 102) are movably connected with each other, being able to make a relative movement with respect to each other. As water waves fluctuate, two adjacent buoyant members (101, 102) rotate relatively, with an axis of a hinge shaft as the centre line, so as to drive the power transmission device and the energy conversion device (103) on the buoyant members to make a relative movement, thereby achieving energy conversion. The energy conversion device is a line type generator, a rotary generator driven by a rack and pinion, a hydraulic oil cylinder, a pneumatic cylinder or a hydraulic cylinder. The conversion system can utilize water wave energy effectively, has a simple structure and is low cost, thereby facilitating implementation and application.

### BACKGROUND

1. Field of the Invention

The invention generally relates to water wave energy technology, more particularly, to a floating water wave energy collection and conversion system.

2. Relevant Background

Water waves, also known as water ripples or just waves, are a kind of mechanical waves which are formed by rivers, lakes, oceans and/or other water bodies under the influence of natural factors such as wind and temperature difference. Water waves, in particular, ocean waves, have huge power and are very important energy resources. Energy contained in water waves is referred as water wave energy. Compared to petroleum, coal and natural gas, which are traditional energy resources, water wave energy has large reserves, no pollution and sustainable use.

In recent years, with the tension between supply and demand of traditional energy resources and the enhancement of environmental consciousness, more and more attention about water wave energy has been arising. A large number of inventions in terms of the water wave energy are explored and a wide variety of technology solutions are presented. From the disclosed technical literatures, the proposed solutions about water wave energy are mainly to generate power from ocean waves.

For example, a Chinese Utility Model Patent entitled “a floating type ocean waves power generation device” with patent No. 200820212914.4 and announcement No. CN201277140Y discloses a floating type ocean waves power generation device, which includes:

a pair of sealed floating boxes located on the left side and the right side respectively, with a certain distance between them; wherein these two floating boxes are hinged to a rib plate perpendicular to the side of the boxes and when the floating boxes float with the fluctuation of the ocean waves, they can rotate a certain angle around the shaft of the hinge;

two crank-connecting rod mechanisms, wherein one end of each connecting rod is hinged to a connecting rod bearing, which is close to the inside and fixed on the respective floating box, and the other end of each connecting rod is hinged to the eccentric shaft of the crank; and each end of the crank is supported by the respective crank bearing fixed to the two floating boxes;

two power generators, each installed on a power generator bearing and driven by the respective crank-connecting rod mechanism via a speed-increase device.

In general, the prior art including the Chinese Utility Model patent No. 200820212914.4 did a beneficial research on the usage of ocean wave energy. However, existing ocean waves power generation devices have complex structures and too many energy conversion links, resulting in high production costs and low wave energy conversion efficiency.

### SUMMARY

The purpose of this invention is to provide a floating water wave energy collection and conversion system which can overcome the shortcomings of the existing ocean waves power generation devices, for example, complex structures and too many energy conversion links, thereby sharply enhancing the industrialization level of water wave energy utilities.

In order to solve at least one of the technical problems mentioned above, the following technical solutions are set forth:

A floating water wave energy collection and conversion system, comprising: at least two buoyant members movably connected to each other in series and floating on water surface; power transmission device and energy conversion device provided on the buoyant members; the energy conversion device can be line type generator, hydraulic oil cylinder or hydraulic cylinder. The power transmission device and the energy conversion device on adjacent buoyant members are movably connected. The buoyant member makes a relative movement with the adjacent one as the water waves move, and thus the power transmission device on the buoyant member makes a reciprocating and relative motion with the energy conversion device on the adjacent buoyant member, thereby resulting in energy conversion.

Energy conversion principle of the abovementioned technical solution is that water waves are caused by the interaction between natural forces such as wind and water surface. Fluctuations in water waves push the buoyant members floating on the water surface. Due to transmission of water waves, the adjacent buoyant members move asynchronously. This lack of synchronization can result in relative motion of the adjacent buoyant members. This relative motion of the adjacent buoyant members often appears as an asynchronous up and down movement and/or a relative rotation with respect to the connection point. This relative motion of the adjacent buoyant members can cause the relative motion of the power transmission device and the energy conversion located on the adjacent buoyant members and movably connected to each other. In fact, this is to pass “surface energy,” i.e., the mechanical energy obtained by all the buoyant members, to the “point,” i.e., the energy conversion device (including but not limited to a line type generator), so that low density of water wave energy can be overcome.

On the basis of the above technical solution, the invention further sets forth the following technical solution:

A hinge seat is provided on each of the opposite ends of the adjacent buoyant members for movably connecting two adjacent buoyant members. The power transmission device includes a power drive rod and a power diverter. One end of the power drive rod is movably connected to a fixing seat fixed to one of the buoyant members and the other end of the power drive rod is movably connected to one end of the power diverter. The other end of the power diverter is movably connected to the energy conversion device on the adjacent buoyant member. The energy conversion device is movably connected to the fixing seat fixed to the buoyant member.

The adjacent two buoyant members make a relative rotation around the shaft of the hinge seat as the water waves fluctuate and drive the power diverter via the power drive rod to make a reciprocating relative motion with the energy conversion device.

Furthermore, the number of the buoyant members is more than three and a hinge seat is provided on each of the opposite ends of the adjacent buoyant members; in the three buoyant members connected in order from left to right, the left buoyant member is hinged to the middle one via a hinge seat and the middle one is hinged to the right one via a hinge seat.

A lug boss is provided on the right top of the left buoyant member, and a fixing seat is provided on the side of the lug boss. A lug boss is provided on the right top of the middle buoyant member, and a fixing seat is provided on the side of the lug boss.

A fixing seat is provided on the left top of the side of the middle buoyant member and a fixing seat is provided on the left top of the side of the right buoyant member.

An energy conversion device is provided on the left buoyant member. One end of the energy conversion device is movably connected to the fixing seat on the side of the lug boss. The other end of the energy conversion device is movably connected to one end of the power diverter. The other end of the power diverter is movably connected to one of the power driver rod. The other end of the power driver rod is movably connected to the fixing seat on the left top of the side of the middle buoyant member.

An energy conversion device is provided on the middle buoyant member. One end of the energy conversion device is movably connected to the fixing seat on the side of the lug boss. The other end of the energy conversion device is movably connected to one end of the power diverter. The other end of the power diverter is movably connected to one end of the power driver rod. The other end of the power driver rod is movably connected to the fixing seat on the left top of the side of the middle buoyant member. It is noted that the orientations of left, right, left side, middle or center, right side, the left top of the side and the right top recited in the technical solutions are referred to that shown in FIG. 4.

Furthermore, the power transmission device can be rod-shaped, plate-shaped or cylinder-shaped, and the energy conversion device can be cylindrical, cube or sphere. The power transmission device and the energy conversion device can be connected by sockets, plugs, racks, gears or by welding.

Furthermore, at least one of the power transmission devices is provided on each of the buoyant members.

Furthermore, the power transmission device and the energy conversion device are provided on the upper surface, the lower surface, the side of the buoyant members, or in the inside of the buoyant members.

In order to overcome the shortcomings of the complex structure and too many energy conversion links in the existing ocean waves power generation devices, the present invention also sets forth another technical solution as follows:

A floating water wave energy collection and conversion system, comprising: at least two buoyant members movably connected to each other in series and floating on the water surface; a fixing seat is arranged on each of the buoyant members; an energy conversion device is connected between the fixing seats of the adjacent buoyant members. The adjacent buoyant members make a relative movement as the water waves move, thereby causing the energy conversion device to perform energy conversion. This technical solution is characterized by that the energy conversion device achieves energy conversion under the direct effect of the relative movement of the adjacent buoyant members, which means that no power transmission device but the buoyant members is provided to transmit power or energy to the energy conversion device. Instead, the buoyant members directly transmit the power of the water waves to the energy conversion device and then the energy conversion device performs energy conversion.

Furthermore, a hinge seat is provided on the opposite ends of the adjacent buoyant members, by which the adjacent buoyant members are hinged. The fixing seat is provided on the top of the buoyant members. The energy conversion device is connected between the fixing seats of the two adjacent buoyant members. The buoyant members make a relative rotation around the hinge shaft of the hinge seat under the action of water waves, which pushes and pulls the energy conversion device. These two forces of push and pull cause the energy conversion device to achieve the energy conversion.

Furthermore, the energy conversion device includes moving parts and fixed parts, which make a relative motion when the adjacent buoyant members make a relation movement.

Furthermore, the energy conversion device is cubic, cylindrical or spherical. Furthermore, as to the floating water waves energy collection and conversion system without the power transmission device, the energy conversion device is provided on the upper surface, the lower surface, the side of the buoyant members, or in the inside of the buoyant members.

Furthermore, a hinge seat includes a rib with a hole through which a hinge pin passes.

Furthermore, a shaft sleeve is arranged around the hinge pin.

Furthermore, a ceramic bearing is arranged around the hinge pin and a seal member is arranged in the bearing.

Furthermore, one end of the energy conversion device is movably connected to a bracket of the hinge seat on one of the buoyant members and the other end thereof is movably connected to the fixing seat on the other of the buoyant members.

Furthermore, the hole center of the bracket of the hinge seat and the hole center of the hinge seat are coaxial in the radial direction.

Furthermore, at least one energy conversion device is arranged on each of the buoyant members.

Furthermore, the horizontal cross-section of the buoyant member is square, round, oval, triangular or polygonal.

Furthermore, each of the buoyant members can rotate around the center line from counterclockwise 80° to clockwise 80°, wherein the center line refers to the horizontal direction of the connection of the buoyant members.

Furthermore, the energy conversion device can be a line type generator, a rotary generator driven by a rack and pinion, a hydraulic oil cylinder, a pneumatic cylinder or a hydraulic cylinder.

To be noted that, all of the line type generator, the rotary generator driven by a rack and pinion, the hydraulic oil cylinder, the pneumatic cylinder and the hydraulic cylinder may use the energy conversion devices in the prior art.

Furthermore, the area of the buoyant member ranges from 0.01 to 1000 square meters (m²).

The following further explains the area of the buoyant member. The buoyant member is a kind of device for converting “surface energy” into “point energy.” In order to make the energy conversion device obtain sufficient energy, the area of the buoyant member should be large enough. However, if the area of the buoyant member is too big, the buoyant member will be stable but difficult to perform effective energy conversion. In addition, the size of the buoyant member is directly related to the size of the water body. For example, in the brook, the buoyant member with the area of 0.01 square meters can achieve ideal technical effective; whereas in the sea, the area of the buoyant member can be set very big. According to our practice, the buoyant member with the area of 0.01˜1000 square meters is ideal depending on factors such as the size of water body and wind levels.

Furthermore, when the horizontal cross-section of the buoyant member is a square or oval, the length-width ratio of the buoyant member is set within the range of 30 to 1 in order to maintain the stability of the buoyant member.

In order to overcome the shortcoming of complex structure and too many energy conversion links of the existing ocean waters power generation devices, the present invention further provides the following two technical solutions:

A floating water wave energy collection and conversion system, comprising: at least two buoyant members connected to each other in series and floating on the water surface; hinge seats arranged on opposite ends of the adjacent buoyant members which are hinged by these hinge seats; the housing of an energy conversion device is fixed to one of the buoyant member; the central shaft of the energy conversion device is fixed to a hinge pin for hinged connection; the hinge pin is fixed to the adjacent other buoyant member. The adjacent buoyant members make a relative movement as the water waves move, thereby causing the housing and the central shaft of the energy conversion device to move relatively and thus perform energy conversion.

A floating water wave energy collection and conversion system, comprising: at least two buoyant members connected to each other in series and floating on the water surface; hinge seats are arranged on opposite ends of the adjacent buoyant members which are hinged by these hinge seats. The adjacent buoyant members make a relative movement as the water waves move and this movement drives the hinge pin fixed to one of the buoyant member to make a relative movement with respect to the other buoyant member, thereby causing the big gear on the hinge pin to rotate, which further drives the small gear on the energy conversion device of the other buoyant member to rotate and thus makes the energy conversion device perform energy conversion.

In order to maintain the stability of the floating water wave energy collection and conversion system, particularly to improve collection efficiency thereof, the present invention further provides the following technical solution: both of the buoyant members respectively located on two ends of the floating water wave energy collection and conversion system are flexibly connected to a fixing device at the bottom of the water body, respectively.

The present invention has the following advantages:

1. Efficient use of water wave energy on the industrial level. With respect to energy conversion, the bigger is the buoyant member, the more kinetic energy of water waves is obtained and thus the more energy is converted. Thus, the present invention may effectively utilize the water wave energy on the industrial level.

2. Environmental protection. Effective utilization of water wave energy will reduce the consumption of coal, oil, natural gas and others which can lead to the serious environment pollution.

3. Simple structure. In particular, the energy conversion device of the floating water wave energy collection and conversion system in the present invention may use a line type generator, a rotary generator driven by a rack and pinion, a hydraulic oil cylinder, a pneumatic cylinder or a hydraulic cylinder in the prior art and, therefore, the present invention also has the advantages of low cost and ease of application.

### BRIEF DESCRIPTION OF THE DRAWINGS

FIG. 1 is a schematic diagram of the first embodiment of the present invention;

FIG. 2 is a schematic diagram of the second embodiment of the present invention;

FIG. 3 is a schematic diagram of the third embodiment of the present invention;

FIG. 4 is schematic diagram of the fourth embodiment of the present invention;

FIG. 5 is schematic diagram of the fifth embodiment of the present invention;

FIG. 6 is schematic diagram of the sixth embodiment of the present invention;

FIG. 7 is schematic diagram of the seven embodiment of the present invention;

FIGS. 8A and 8B are schematic diagrams of the eighth embodiment of the present invention.

### DETAILED DESCRIPTION

### Embodiment 1

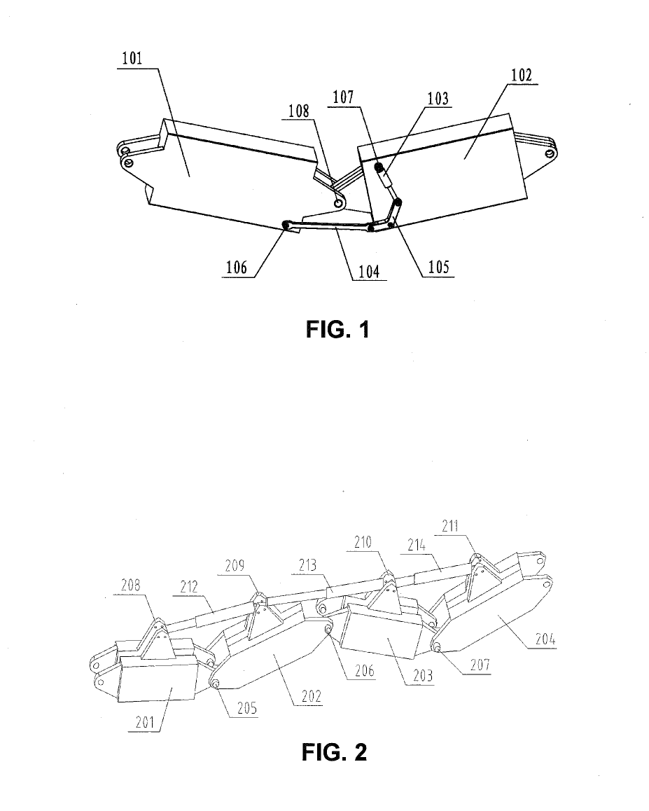

As shown in FIG. 1, the floating water wave energy collection and conversion system includes two buoyant members 101 and 102, floating on the water surface and movably connected with each other by a hinge seat 108. An energy conversion device 103 is provided on the buoyant member 102. A power transmission device is provided on the buoyant member 101, which includes a power drive rod 104 and a power diverter 105. One end of the power drive rod 104 is movably connected to a fixing seat 106 fixed to one of the buoyant members. The other end of the power drive rod 104 is movably connected to one end of the power diverter 105. The other end of the power diverter 105 is movably connected to the energy conversion device 103 on the adjacent buoyant member. The energy conversion device 103 is movably connected to the fixing seat 107 fixed to the buoyant member 102.

Buoyant members 101 and 102 make a relative movement around the shaft of the hinge seat 108, i.e., the hinge shaft, with the fluctuation of water waves and drive the power diverter 105 and the energy conversion device 103 to make a reciprocating motion via the power drive rod 104. In this embodiment, the energy conversion device 103 can be a line type generator. When the power diverter 105 and the energy conversion device 103 make a reciprocating motion, the mechanical energy is converted into electricity.

In order to maintain the stability of the floating water wave energy collection and conversion system, particularly to improve collection efficiency thereof, both of the buoyant members respectively located on two sides of the floating water wave energy collection and conversion system are flexibly connected to the fixing device at the bottom of the water body, respectively.

In this embodiment, the number of the buoyant members movably connected to each other through hinge seats and floating on the water surface can be more than two.

### Embodiment 2

As shown in FIG. 2, a floating water wave energy collection and conversion system includes four buoyant members 201, 202, 203 and 204 floating on the water surface and movably interconnected with each other in series. The buoyant member 201 and the buoyant member 202 are hinged via a hinge seat 205, the buoyant member 202 and the buoyant member 203 are hinged via a hinge seat 206, and the buoyant member 203 and the buoyant member 204 are hinged via a hinge seat 207. Fixing seats 208, 209, 210 and 211 are provided on the buoyant members 201, 202, 203 and 204, respectively. An energy conversion device 212 is connected between the fixing seats 208 and 209. An energy conversion device 213 is connected between the fixing seats 209 and 210. An energy conversion device 214 is connected between the fixing seats 210 and 211. The buoyant members 201,202,203 and 204 make a relative movement around the shaft of the hinge seats 205, 206 and 207, respectively, with the fluctuation of water waves, so as to push and pull the energy conversion devices 212, 213 and 214 to achieve energy conversion. In general, in order to achieve energy conversion under the forces of push and pull, it is necessary to set the components for making a relative motion in the energy conversion devices.

### Embodiment 3

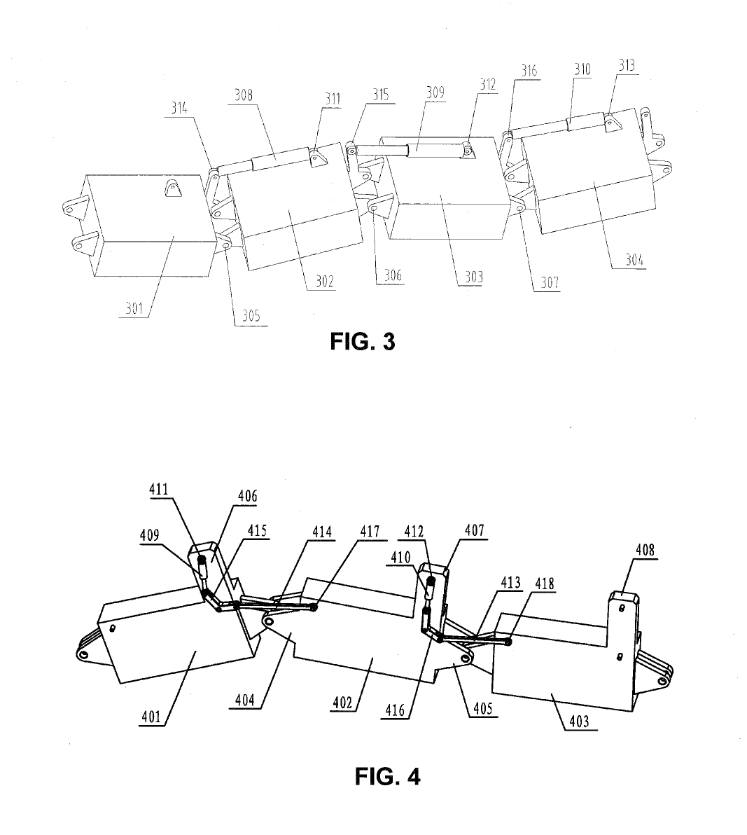

As shown in FIG. 3, a floating water wave energy collection and conversion system includes four buoyant members 301, 302, 303 and 304 floating on the water surface and movably interconnected with each other in series. The buoyant member 301 and the buoyant member 302 are hinged via a hinge seat 305, the buoyant member 302 and the buoyant member 303 are hinged via a hinge seat 306, and the buoyant member 303 and the buoyant member 304 are hinged via a hinge seat 307.

One end of each of energy conversion devices 308, 309 and 310, is movably connected to each of the fixing seats 311,312 and 313 fixed on the buoyant members 302,303 and 304, respectively. The other end of each of energy conversion devices 308, 309 and 310 is movably connected to a bracket 314 on the hinge seat 305, a bracket 315 on the hinge seat 306 and a bracket 316 on the hinge seat 307, respectively.

Buoyant members 301, 302, 303 and 304 make a relative movement around the shaft of the hinge seats 305,306 and 307, respectively, with the fluctuation of water waves so as to push and pull the energy conversion devices 308-310 to achieve energy conversion.

### Embodiment 4

As shown in FIG. 4, a floating water wave energy collection and conversion system includes three buoyant members 401, 402 and 403 floating on the water surface and movably interconnected with each other in series. The buoyant member 401 and the buoyant member 402 are hinged via a hinge seat 404 and the buoyant member 402 and the buoyant member 403 are hinged via a hinge seat 405. Lug bosses 406, 407 and 408 are arranged on the buoyant members 401, 402 and 403, respectively. One end of the energy conversion device 409 is movably connected to the fixing seat 411 fixed to the side of the lug boss 406, and the other end thereof is movably connected to one end of the power diverter 415. The other end of the power diverter 415 is movably connected to one end of the power drive rod 414. The other end of the power driver rod 414 is movably connected to the fixing seat 417 fixed to the side of the buoyant member 402. One end of the energy conversion device 410 is movably connected to the fixing seat 412 fixed to the side of the lug boss 407, and the other end thereof is movably connected to one end of the power drive rod 413. The other end of the power drive rod 413 is movably connected to the fixing seat 418 fixed to the side of the buoyant member 403.

The present embodiment has the same working principle as Embodiment 1 and thereby it is omitted herein.

### Embodiment 5

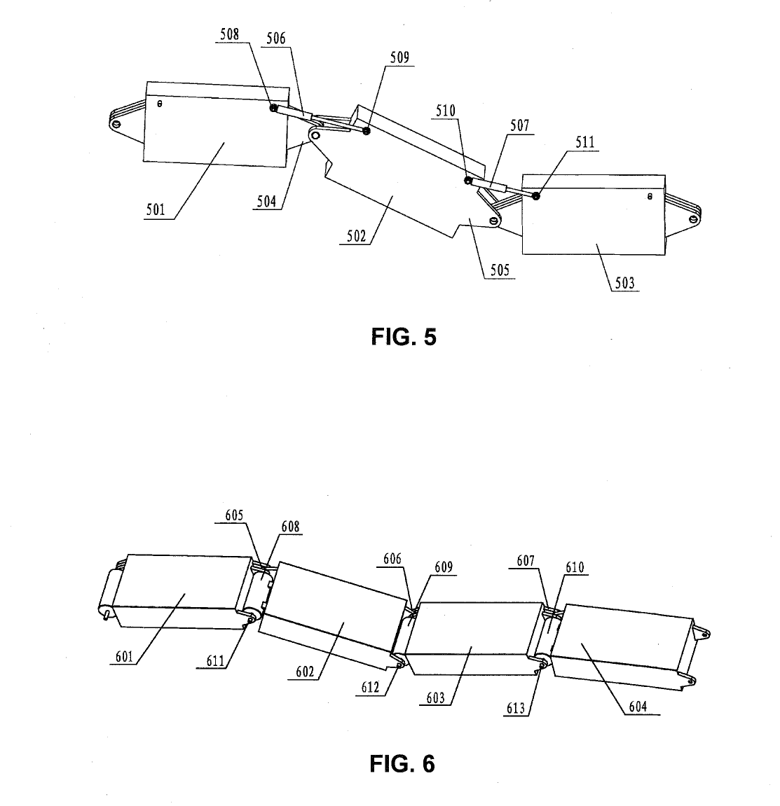

As shown in FIG. 5, a floating water wave energy collection and conversion system includes three buoyant members 501, 502 and 503 floating on the water surface and movably interconnected with each other in series. The buoyant member 501 and the buoyant member 502 are hinged via a hinge seat 504, and the buoyant member 502 and the buoyant member 503 are hinged via a hinge seat 505. One end of the energy conversion device 506 is movably connected to the fixing seat 508 fixed to the side of the buoyant member 501, and the other end thereof is movably connected to the fixing seat 509 fixed to the side of the buoyant member 502. One end of the energy conversion device 507 is movably connected to the fixing seat 510 fixed to the side of the buoyant member 502, and the other end thereof is movably connected to the fixing seat 511 fixed to the side of the buoyant member 503.

The present embodiment has the same working principle as Embodiment 2 and thereby it is omitted herein.

### Embodiment 6

As shown in FIG. 6, a floating water wave energy collection and conversion system includes four buoyant members 601, 602, 603 and 604 floating on the water surface and movably connected with each other in series. Hinge seats 605, 606 and 607 are arranged on the opposite ends of the above buoyant members, respectively. The adjacent buoyant members are hinged via hinge seats, respectively. The housings of the energy conversion devices 608, 609 and 610 are fixed on the end surfaces of the buoyant members 602, 603 and 604. The center shafts of the energy conversion devices 608, 609 and 610 are fixed to the hinge pins 611, 612 and 613 for hinging to the hinge seats, respectively. The hinge pin 611 is fixed to the buoyant member 601, the hinge pin 612 is fixed to the buoyant member 602 and the hinge member 613 is fixed to the buoyant member 603. The adjacent two buoyant members make a relative movement with the fluctuation of water waves to drive the housings and the center shafts of the energy conversion devices to make a relative movement so as to achieve energy conversion.

### Embodiment 7

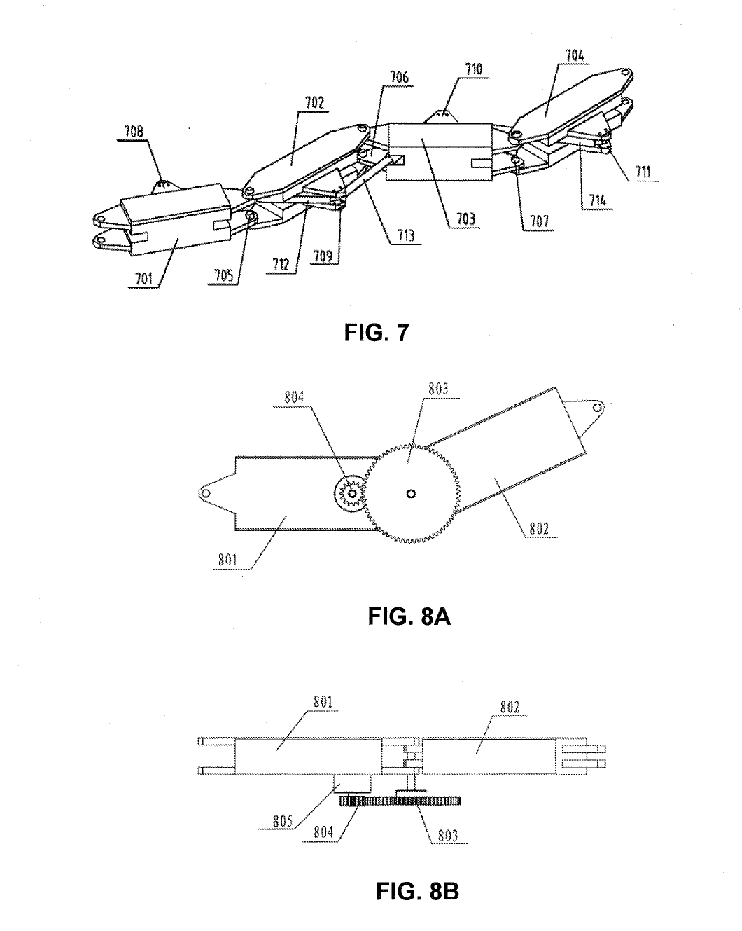

As shown in FIG. 7, a floating water wave energy collection and conversion system includes four buoyant members 701, 702, 703 and 704 floating on the water surface and movably connected with each other in series. The buoyant member 701 and the buoyant member 702 are hinged via a hinge seat 705, the buoyant member 702 and the buoyant member 703 are hinged via a hinge seat 706, and the buoyant member 703 and the buoyant member 704 are hinged via a hinge seat 707.

The fixing seats 708 and 710 are arranged on the top surfaces of the buoyant members 701 and 703, respectively, and the fixing seats 709 and 711 are arranged on the bottom surfaces of the buoyant members 702 and 704, respectively. The energy conversion device 712 is connected between the fixing seats 708 and 709, the energy conversion device 713 is connected between the fixing seats 709 and 710 and the energy conversion device 714 is connected between the fixing seats 710 and 711. The present embodiment has the same working principle as Embodiment 2 and thereby it is omitted herein.

### Embodiment 8

As shown in FIG. 8A and FIG. 8B, a floating water wave energy collection and conversion system includes two buoyant members 801 and 802, floating on the water surface and movably connected with each other. The hinge seats are arranged on the opposite ends of the buoyant members 801 and 802 which are hinged by the hinge seats. The buoyant members 801 and 802 make a relative rotation with the fluctuation of water waves and drive the hinge pin fixed to the buoyant member 802 to rotate with respect to the buoyant member 801, thereby causing the big gear 803 arranged on the hinge pin to rotate. The big gear 803 then drives the small gear 804 on the energy conversion device 805 arranged on the other buoyant member to rotate. Then, the small gear 804 drives the energy conversion device 805 (for example, a power generator) to perform energy conversion.

The embodiments of the present invention are described as above. However, the person skilled in the art should understand that the present invention is not limited to the above embodiments and includes many variants of the embodiments. For example, the power transmission device and the energy conversion device can be arranged on the top surface, the bottom surface, the side of the buoyant members or in the inside of the buoyant members. Further, the shape of the buoyant members may also be rectangular, spherical, and cylinder. Furthermore, in the present invention, the number of the buoyant members in the floating water wave energy collection and conversion system can be set differently dependent on actual need, usually up to several tens, several hundreds and even more. In short, any improvement, equivalent replacement and/or changes made within the spirit and principles of the present invention should be included within the scope of protection of the invention.

1-25. (canceled)

26. A floating water wave energy collection and conversion system, comprising:
at least two buoyant members, movably connected with each other in series and floating on water surface; and
an energy conversion device arranged on the buoyant members for performing energy conversion via relative movement of the adjacent buoyant members as water wave fluctuates.

27. The floating water wave energy collection and conversion system of claim 26, further comprising:
fixing seats arranged on the buoyant members, respectively; and
wherein the energy conversion device is connected between two adjacent fixing seats.

28. The floating water wave energy collection and conversion system of claim 27, wherein each of the fixing seats is located on the top surface or the side surface of each of the buoyant members, or the adjacent fixing seats are located on the top surface and the bottom surface of the buoyant members, respectively.

29. The floating water wave energy collection and conversion system of claim 27, wherein the energy conversion device are connected between two adjacent fixing seats via a power transmission device.

30. The floating water wave energy collection and conversion system of claim 29, wherein the power transmission device comprises a power drive rod and a power diverter, and wherein one end of the power drive rod is movably connected to a fixing seat on one of the buoyant members and the other end thereof is movably connected to one end of the power diverter; wherein the other end of the power diverter is movably connected to the energy conversion device which is connected to a fixing seat on the adjacent buoyant member.

31. The floating water wave energy collection and conversion system of claim 29, wherein a lug boss is arranged on each of the buoyant members and the fixing seat directly connected to the energy conversion device is arranged on the lug boss.

32. The floating water wave energy collection and conversion system of claim 27, wherein hinge seats are arranged on the opposite ends of the adjacent buoyant members which are movably connected via the hinge seats;
wherein a bracket is set on one of the adjacent hinge seats; and
wherein one of the adjacent fixing seats is arranged on the bracket and the other one is arranged on the top surface of the buoyant member on which the other one of the adjacent hinge seats is arranged.

33. The floating water wave energy collection and conversion system of claim 26, further comprising:
hinge seats arranged on opposite ends of the adjacent buoyant members which are hinged via these hinge seats;
wherein the housing of the energy conversion devices is fixed to one of the buoyant members; the central shaft of the energy conversion devices is fixed to a hinge pin for hinging;
wherein the adjacent buoyant members make a relative movement as the water waves move, thereby causing the housing and the central shaft of the energy conversion devices to move relatively and perform energy conversion.

34. The floating water wave energy collection and conversion system of claim 26, further comprising:
a small gear provided on the energy conversion device;
a big gear provided on a hinge pin for hinging on the adjacent buoyant members and engaged with the small gear;
wherein the adjacent buoyant members make a relative movement as the water wave fluctuates and drives the hinge pin to cause the big gear on the hinge pin to rotate, which further drives the small gear on the energy conversion device of the other buoyant member to rotate and thus makes the energy conversion device perform energy conversion.

35. The floating water wave energy collection and conversion system of claim 29, wherein the power transmission device is rod-shaped, plate-shaped or cylinder-shaped, and the energy conversion device is cylindrical, cube or sphere; and wherein the power transmission device and the energy conversion device is connected by sockets, plugs, racks, gears or by welding.

36. The floating water wave energy collection and conversion system of claim 32, wherein the hinge seat includes a rib with a hole through which a hinge pin passes.

37. The floating water wave energy collection and conversion system of claim 36, wherein a shaft sleeve is arranged around the hinge pin.

38. The floating water wave energy collection and conversion system of claim 36, wherein a ceramic bearing is arranged around the hinge pin and a seal member is arranged in the bearing.

39. The floating water wave energy collection and conversion system of claim 32, wherein the hole center of the bracket of the hinge seat and the hole center of the hinge seat are coaxial in the radial direction.

40. The floating water wave energy collection and conversion system of claim 26, wherein the horizontal cross-section of the buoyant member is square, round, oval, triangular or polygonal.

41. The floating water wave energy collection and conversion system of claim 26, wherein each of the buoyant members rotates around the center line from counterclockwise 80° to clockwise 80°, wherein the center line is the horizontal direction of the connection of the buoyant members,.

42. The floating water wave energy collection and conversion system of claim 26, wherein the energy conversion device is a line type generator, a rotary generator driven by a rack and pinion, a hydraulic oil cylinder, a pneumatic cylinder or a hydraulic cylinder.

43. The floating water wave energy collection and conversion system of claim 26, wherein the area of the buoyant member ranges from 0.01 to 1000 square meters.

44. The floating water wave energy collection and conversion system of claim 26, wherein when the horizontal cross-section of the buoyant members is a square or oval, the length-width ratio of the buoyant members is set within the range of 30 to 1.

45. The floating water wave energy collection and conversion system of claim 26, wherein both of the buoyant members respectively located on two ends of the floating water wave energy collection and conversion system are flexibly connected to a fixing device at the bottom of the water body, respectively.
